(19) United States
(12) Patent Application Publication
(10) Pub. No.: US 2004/0232397 A1
(43) Pub. Date: Nov. 25, 2004

(54) Multi-Lift

(76) Inventor: Cedric Laster, Douglasville, GA (US)

Correspondence Address: Cedric Laster, 7789 Mountain Creek Way, Douglasville, GA, 30134, US

(21) Appl. No.: 10/428,485

(22) Filed: May 5, 2003

(51) Int. Cl. B66D 1/00

(52) U.S. Cl. 254/324

(57) ABSTRACT

A castered, steel tubular frame lift assembly including a movable trolley and chain hoist lift supported by a plurality of detachable telescoping support parts including pins, bolts, washers and nuts mating with the supports, and the support rails, The supports and the support rails are used to assemble the work piece. The trolley supports the chain hoist and a variety of chains and support harnesses.

### BACKGROUND OF THE INVENTION

The present invention relates to utility lifting assemblies and, in particular, to a steel tubular, castered, multi-purpose assembly adaptable to a variety of general, industrial and automotive repair applications.

A problem long plaguing industrial, automotive and heavy equipment repair and maintenance personnel is how to efficiently handle major equipment assemblies and subassemblies overhead lifting, such as truck cabs, truck beds, car bodies, engines, transmissions, differential gears, axles, steel frames, and heavy industrial equipment. In most cases a vehicles weight is sufficiently great to the point where a regular hoist or a buildings steel beam is either unable or unavailable to lift the item to comfortable working height. Although repair pits and regular engine hoist have been used in some of such circumstances, the problem still remains of how to manipulate and manhandle the vehicle assemblies, and subassemblies, especially when items weigh hundreds to thousands of pounds. When using a pit, one might detach the subassembly and capture it on a lower upright support, prior to manually pushing the vehicle away from the pit to permit removal of the assembly or subassembly from beneath the vehicle. Needless to say, such efforts are rather tedious and difficult, especially for vehicles capable of supporting loads in excess of one ton.

### BRIEF DESCRIPTION OF THE DRAWINGS

FIG. 0 shows an assembled isometric view of the lift assembly of the present invention

FIG. 1 shows a view of the trolley manual or automated.

FIG. 2 shows a view of a chain hoist manual or automated.

FIG. 3 shows a view of a chain-link lift hook detachable and interchangeable.

FIG. 4 shows a view of a top support.

FIG. 5 shows a view of a support rail.

FIG. 6 shows a view of a middle support.

FIG. 7 shows a view of a bottom support.

FIG. 8 FIG. 8 shows a view of a telescoping adjustable length caster support. The casters used can be hard rubber, pneumatic, or steel and are interchangeable, they enable users to operate this lift on land, concrete, asphalt etc. 2.5″×2.5″×3/16″×301/4″ with four drilled holes 6″ apart, and starting 3″ from each side of the openings in the steel.

FIG. 9 shows a view of one of the eight pin holes used for adjusting the length of the caster support.

FIG. 10 shows a view of a quick-disconnecting pin used to detach caster supports, or free-standing support.

FIG. 11 shows a view of a 3″ wide motor support rail, that runs the length of the top support rail and used to support the electric motor, that enables objects to move left to right on the multi-lift.

FIG. 12 shows a view of the motor used to support the weight of the objects being lifted. (optional)

### DESCRIPTION OF THE PREFERRED EMBODIMENT

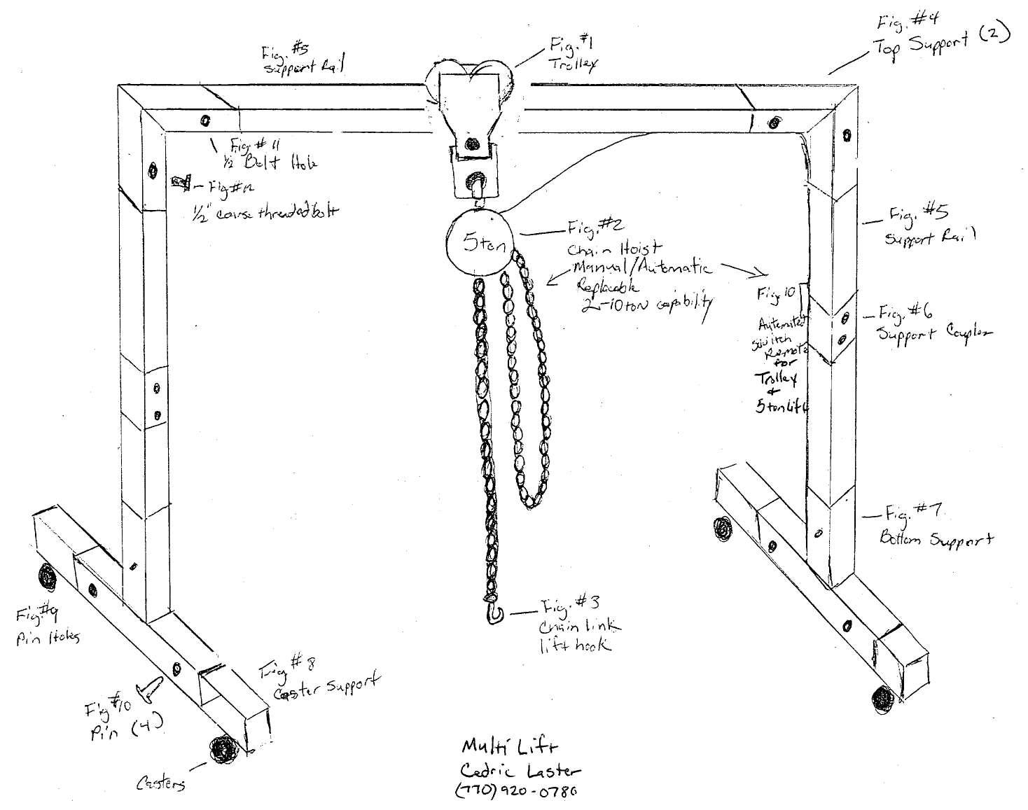

FIG. 0 shows an assembled isometric view of the lift assembly of the present invention with all of its components. This unit is a portable unit it can be used as a stationary assembly or mobile assembly. All drilled holes will be centered in this drawing.

FIG. 1 shows a view of the modified trolley used to travel from left to right manually or automated with or without any items being lifted on the top support rail.

FIG. 2 shows a view of the chain hoist which can lift items manually or automated.

FIG. 3 shows a view of a chain-link lift hook, sizes can be changed as needed to support what is being lifted.

FIG. 4 shows a view of a top support, made of two pieces of 3″×3″×3/16″×18″×18″ tubular steel joined together by the ends being cut on each piece of steel at 45 degree angles and when both 45 degrees angles join together form a 90 degree angle and welded together at all four sides to form an (L).

Once the top support is formed as an (L) measure from both open end of the assembly up on the steel 8.5″ and drill one 9/16″ thru hole on each outer side of the assembly for a ½″×4″ coarse thread hardened bolt and nut. It takes two top supports to assemble this lift.

FIG. 5 shows a view of a support rail, made of 2.5″×2.5″×3/16″×10′ tubular steel with one 9/16″ thru hole drilled from each open end of the steel up 8.5″ for a ½″×4″ coarse thread hardened bolt and nut.

FIG. 6 shows a view of a middle support, made of 2.5″×2.5″×3/16″×10′ tubular steel with one 9/16″ thru hole drilled from each open end of the steel up 8.5″ for a ½″×4″ coarse thread hardened bolt and nut.

FIG. 7 shows a view of a bottom support, 3″×3″×3/16″×3′ tubular steel with two 9/16″ centered holes from each opening 6″ apart thru holes an a 3″×3″×3/16″×18″ piece of tubular steel centered vertically on top of the 3″×3″×3/16″×3′ tubular steel with all four sides welded, measure from the top of horizontal piece of steel 8.5″ on the inner vertical piece of tubular steel that forms two (L)'s drill one centered 9/16″ thru hole for a ½″×4″ coarse thread hardened bolt and nut.

When joined together forms an upside down (T) two are needed for this lift to function. The bottom support enables the lift to be used as a stationary unit or to operate as a mobile unit

FIG. 8 shows a view of a telescoping adjustable length caster support.

The casters used can be hard rubber, pneumatic, or steel and are interchangeable, they enable users to operate this lift on land, concrete, asphalt etc.

2.5″×2.5″×3/16″×301/4″ with four drilled holes 6″ apart, and starting 3″ from each side of the openings in the steel.

FIG. 9 shows a view of the 7/16″ eight pin holes used for adjusting the length of the caster supports and the free standing supports (non-mobile).

FIG. 10 shows a view of a 7/16×3.5″ quick-disconnecting pin used to detach caster supports or free-standing support.

FIG. 11 shows a view of a 3″ wide motor support rail, that runs the length of the top support rail and used to support the electric motor, that enables objects to move left to right on the multi-lift.

FIG. 12 shows a view of the motor used to support the weight of the objects being lifted (optional).

What claimed is:

1. A portable, mobile or stationary lift assembly with telescoping tubular components comprising of,
(a) A ground supported framework assembly including a plurality of frame members telescoping by top supports, rails, middle supports and bottom supports for extending the lengths and the heights, and bottom supports for stability, stationary and mobility on concrete or land.
(b) A trolley is mounted to said frame work, manual or automated.
(c) A chain hoist is mounted trolley, manual or automated.
(d) A plurality of transition supports and rails telescoping and mounted to one another include means for length, adjustably securing one to the other, with quick-disconnect pins, bolts, nuts and washers.
(e) The trolley wheel has shouldered sides that allows it glide along the top rail, this is also the means for securing the trolley to the work piece, whereby the work piece may support items being lifted and make them mobile.

2. Apparatus as set forth in claim 1 wherein said framework includes a trolley for moving items being lifted from left to right and slotted for attachment of a hand-operated or automated chain hoist.

3. Apparatus as set forth in claim 1 including a plurality of wheeled casters for concrete or land mounted that are detachable to said framework with telescoping steel or caster supports.

4. Apparatus as set forth in claim 1 wherein said plurality of supports and rails members comprise mating length-adjustable portions which telescope to mount to one another.

5. Apparatus as set forth in claim 1 wherein supports enable mounting rails for extended length and includes quick-disconnect pins, bolts, washers, and nuts for stability.

6. Apparatus as set forth in claim 1 includes through holes in supports and rails aligning one with other to support pins, bolts, washers, and nuts for mounting through said aligned holes.

7. A steel frame lift assembly comprising Support tops, middle, and bottoms, support rails, trolley, chain hoist support pins, bolts, washers, nuts, caster supports, a free standing support with misc. attachments for lifting.
